(19) United States
(12) Patent Application Publication
(10) Pub. No.: US 2025/0069244 A1
(43) Pub. Date: Feb. 27, 2025

(54) DATA PROCESSING APPARATUS, DATA PROCESSING METHOD, AND PROGRAM

(71) Applicant: NIPPON TELEGRAPH AND TELEPHONE CORPORATION, Tokyo (JP)

(72) Inventors: Takashi SANO, Musashino-shi, Tokyo (JP); Masato ONO, Musashino-shi, Tokyo (JP); Yumi KIKUCHI, Musashino-shi, Tokyo (JP); Shinji FUKATSU, Musashino-shi, Tokyo (JP)

(73) Assignee: NIPPON TELEGRAPH AND TELEPHONE CORPORATION, Tokyo (JP)

(21) Appl. No.: 18/685,937

(22) PCT Filed: Sep. 6, 2021
(86) PCT No.: PCT/JP2021/032680

§ 371 Date: Nov. 14, 2024

(51) Int. Cl. G06T 7/50; G06T 7/11; G06T 7/136; G06T 7/187; G06T 19/20; G06V 20/70

(52) U.S. Cl. CPC G06T 7/50; G06T 7/11; G06T 7/136; G06T 7/187; G06T 19/20; G06V 20/70; G06T 2219/2016

(57) ABSTRACT

A data processing device processes a depth map in which a depth value is mapped to each pixel of an image displayed on a display. There is a region setting unit, a histogram generation unit, a mapping function generation unit, a first correction processing unit, and a second correction processing unit. The region setting unit sets a contact region in contact with a display surface in the depth map that is a processing target. The histogram generation unit generates a histogram in which the number of pixels belonging to each bin is associated with one of a plurality of bins dividing a range of depth values for a non-contact region that is a region other than the contact region of the depth map. The mapping function generation unit performs clustering of the histogram into a plurality of depth layers.

### TECHNICAL FIELD

Embodiments of the present invention relate to a technique of generating a depth map used to generate a three-dimensional (3D) video.

### BACKGROUND ART

In order to generate a three-dimensional image, a depth map representing depth information of the image is used. The depth map is data generated by mapping distance information (depth information) from the viewpoint for each pixel of the image. The depth map may be expressed in grayscale. In a general 8-bit grayscale (0 to 255), the deepest portion is expressed by a minimum value 0 (black) and the foremost portion is expressed by a maximum value 255 (white). Hereinafter, the depth information will be referred to as a depth value.

A method has been proposed in which a wide depth range is remapped to a subject of interest in a frame by using a depth map to emphasize a stereoscopic effect of the subject of interest (for example, refer to Non Patent Literature 1). Non Patent Literature 1 discloses a method of correcting inversion of a mapping function generated when a depth value of a subject of interest is extended, by using a nonlinear least squares method.

A technique has been filed for specifying an area in which a depth value before extension and a depth value after extension have a negative correlation in a mapping function, and performing correction such that a positive correlation is obtained only in a specified range.

### CITATION LIST

### Non Patent Literature

Non Patent Literature 1: Sangwoo Lee, Younghui Kim, Jungjin Lee, Kyehyun Kim, Kyunghan Lee and Junyoung Noh, “Depth manipulation using disparity histogram analysis for stereoscopic 3D”, The Visual Computer 30 (4): 455-465, April 2014.

### SUMMARY OF INVENTION

### Technical Problem

In general, there is less surrounding image information at the upper, lower, left, and right ends of the frame. Therefore, when a depth map is created on the basis of depth information estimated from a monocular 2D image or a binocular stereo image, the estimation accuracy of the depth information may deteriorate. Even if a mapping function based on depth information with low accuracy is used, it is affected by data of a frame corresponding to a screen edge, and it is difficult to perform effective depth representation. When a 3D video is generated by an incorrect depth value at the screen edge, noise that is not present in an original video may occur. As a result, a feeling of wrongness between the screen edge and the display surface becomes conspicuous, which also causes a viewer's eyes to become tired.

The present invention has been made in view of the above circumstances, and an object of the present invention is to provide a technique of reducing a feeling of wrongness between a screen edge and a display surface and realizing more natural depth representation.

### Solution to Problem

A data processing device according to an aspect of the present invention processes a depth map in which a depth value is mapped for each pixel of an image displayed on a display. The data processing device includes a region setting unit, a histogram generation unit, a mapping function generation unit, a first correction processing unit, and a second correction processing unit. The region setting unit sets a contact region in contact with a display surface in the depth map that is a processing target. The histogram generation unit generates a histogram in which the number of pixels belonging to each bin is associated with one of a plurality of bins dividing a range of depth values for a non-contact region that is a region other than the contact region of the depth map. The mapping function generation unit performs clustering of the histogram into a plurality of depth layers and generates a mapping function for converting a depth value of the non-contact region into a value based on the clustering. The first correction processing unit corrects the depth value of the non-contact region by using the mapping function. The second correction processing unit corrects the depth value of the contact region and continuously connects the depth value of the contact region to the corrected depth value of the non-contact region.

### Advantageous Effects of Invention

According to one aspect of the present invention, it is possible to reduce a feeling of wrongness between a screen edge and a display surface and to realize more natural depth representation.

### BRIEF DESCRIPTION OF DRAWINGS

FIG. 1 is a block diagram illustrating an example of a data processing device according to an embodiment.

FIG. 2 is a view illustrating an example of an outer frame region of an image.

FIG. 3 is a diagram for describing correction of a depth value of the outer frame region.

FIG. 4 is a flowchart illustrating an example of a processing procedure of the data processing device 1.

FIG. 5 is a view illustrating a state in which an object labeled in a region of interest protrudes to the outer frame region.

FIG. 6 is a view illustrating an example of a deformed center region.

FIG. 7 is a functional block diagram illustrating an example of a computer on which functions of the data processing device 1 can be installed.

### DESCRIPTION OF EMBODIMENTS

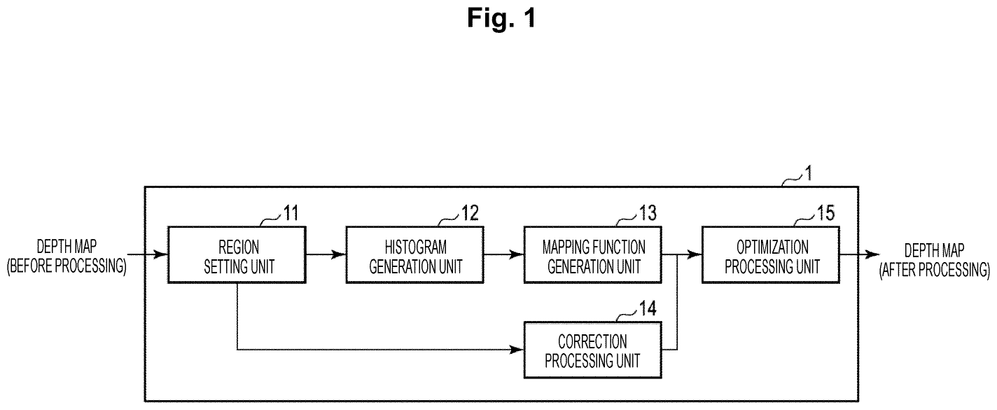

Hereinafter, an embodiment according to the present invention will be described with reference to the drawings. FIG. 1 is a block diagram illustrating an example of a data processing device according to an embodiment. The data processing device illustrated in FIG. 1 is a computer, and has a function of correcting and optimizing a depth value of a depth map of a three-dimensional image frame, for example. The data processing device of the embodiment may be combined with a display that displays an image, and processes a depth map of the image displayed on the display.

The data processing device 1 illustrated in FIG. 1 includes a region setting unit 11, a histogram generation unit 12, a mapping function generation unit 13, a correction processing unit 14, and an optimization processing unit 15.

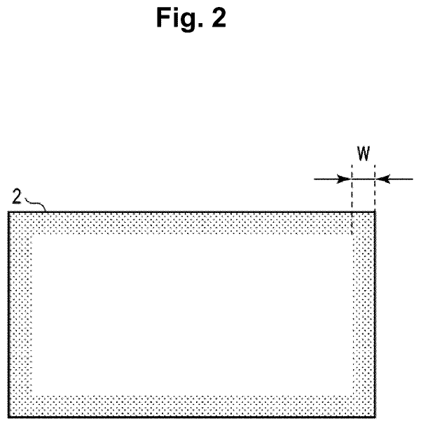

The region setting unit 11 sets a contact region in contact with a display surface in a depth map that is a processing target. That is, as illustrated in FIG. 2, the region setting unit 11 sets a region (hatched) having a constant width on the upper, lower, left, and right sides of an image. In the following description, this region will be referred to as an outer frame region.

In FIG. 2, a width of the outer frame region in contact with a display surface 2 is indicated by w. w may be freely set according to a size of the image. For example, w may be set to several % of a horizontal size of the image for the left and right outer frame regions, and to several % of a vertical size of the image for the upper and lower outer frame regions. It is not essential to provide frames on all the upper, lower, left, and right sides, and, for example, only the horizontal frame, only the vertical frame, or only the left frame may be freely set according to the content of the image. Information regarding the set outer frame region and information regarding a region other than the outer frame region (non-contact region: hereinafter, referred to as a center region) are output to the histogram generation unit 12 and the correction processing unit 14.

The histogram generation unit 12 generates a histogram in which the number of pixels belonging to each bin is associated with one of a plurality of bins dividing a range of the depth values for the center region that is a region other than the outer frame region of the depth map. That is, the histogram generation unit 12 generates a histogram in which a plurality of bins obtained by dividing the depth values and the number of pixels belonging to the bins are associated with each other for the center region. The generated histogram is output to the mapping function generation unit 13 and referred to when a mapping function is generated.

The mapping function generation unit 13 performs clustering of the histogram into a plurality of depth layers, and generates a mapping function that converts a depth value of the center region into a value based on clustering. That is, the mapping function generation unit 13 performs clustering of the histogram into a plurality of depth layers having a Gaussian distribution shape. The mapping function generation unit 13 generates a mapping function that converts a value of the depth map before correction into a value of the depth map after correction by extending a width of a bin belonging to a predetermined depth layer.

As a method of generating a histogram and a mapping function, for example, a method disclosed in PCT/JP2020/028527 may be used. The mapping function may also be referred to as a depth compression function.

The optimization processing unit 15 as a first correction processing unit corrects a depth value of the center region by using the mapping function. That is, the optimization processing unit 15 optimizes the depth value corresponding to the mapping function generated by the mapping function generation unit 13 for the center region.

The correction processing unit 14 as a second correction processing unit corrects the depth value of the outer frame region to be continuously connected to a separately corrected depth value of the center region. That is, the correction processing unit 14 corrects the depth value for the region set as the outer frame region by the region setting unit 11, and outputs the corrected depth value to the optimization processing unit 15.

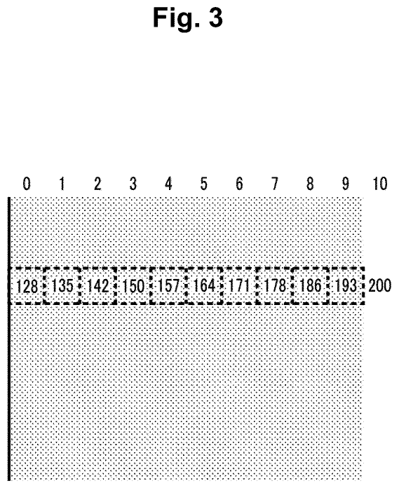

FIG. 3 is a diagram for describing correction of the depth value of the outer frame region. FIG. 3 is an enlarged view of a left end of the outer frame region illustrated in FIG. 2, for example. It is assumed that the hatched portion is an outer frame region set by the region setting unit 11 and has a region width of 10 pixels. In the correction process, first, a depth value of a screen edge (0-th column) is replaced with a depth value corresponding to a display surface.

For example, in an 8-bit depth map, the depth value corresponding to the display surface is generally set to a center value, and thus the correction value is 128. Linear interpolation is performed on depth values between the correction value and the depth value (200) outside the region (tenth column) to correct the depth values. Similarly, linear interpolation is performed from the screen edge toward the center of the image for the right side, the upper side, and the lower side of the image.

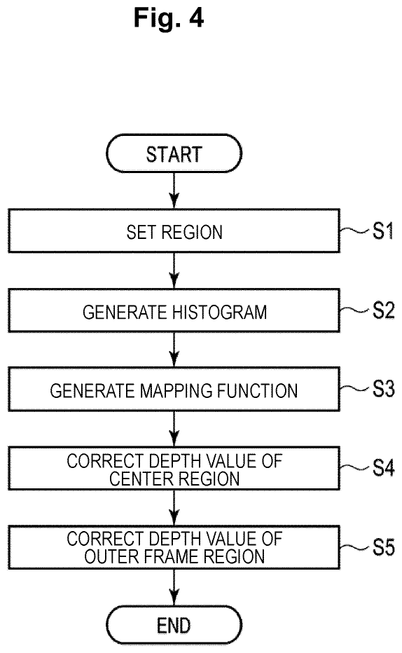

FIG. 4 is a flowchart illustrating an example of a processing procedure of the data processing device 1. In FIG. 4, the data processing device 1 sets an outer frame region and a center region in a depth map that is a processing target (step S1). Next, the data processing device 1 generates a histogram in which the number of pixels belonging to each bin is associated with one of a plurality of bins dividing a range of depth values for the center region (step S2).

Next, the data processing device 1 clusters the generated histogram into a plurality of depth layers, and generates a mapping function for converting the depth value of the center region into a value based on the clustering (step S3).

Next, the data processing device 1 corrects the depth value of the center region by using the mapping function (step S4). Further, the data processing device 1 corrects the depth value of the outer frame region, and continuously connects the depth value of the outer frame region to the corrected depth value of the center region (step S5).

As described above, in the data processing device 1 according to one aspect of the present invention, the region setting unit 11 determines the outer frame region of the image for the depth map that is a processing target. The histogram generation unit 12 generates the histogram in which the number of pixels belonging to each bin is associated with one of a plurality of bins dividing a range of depth values for the center region excluding the outer frame region. The mapping function generation unit 13 performs clustering of the histogram into a plurality of depth layers and generates the mapping function for converting the depth value before optimization in the depth map into the depth value after optimization. The optimization processing unit 15 corrects the depth value of the center region by using the mapping function. The correction processing unit 14 corrects the depth value of the outer frame region to be continuously connected to the depth value of the center region.

That is, in the embodiment, a certain region (outer frame region) is set from the screen edge of the image, and the depth map is generated according to the mapping function that is calculated on the basis of the center region excluding the outer frame region. With this configuration, it is possible to optimize the depth value of the depth map before processing, and thus it is possible to reduce a feeling of wrongness with 3D in the outer frame region of the image and realize highly accurate depth representation as the entire screen. That is, according to the embodiment, it is possible to provide the data processing device, the data processing method, and the program capable of reducing a feeling of wrongness between the screen edge and the display surface and realizing the more natural depth representation.

The present invention is not limited to the above embodiment. For example, a shape of the center region is not limited to a rectangular shape. For example, when the image includes an object of interest (object) and the object protrudes to the outer frame region, a shape of the center region is deformed to trace the contour of the object. In a case where a shape of the image is not a rectangular shape, such as a circular shape or an elliptical shape, the shape of the center region excluding the outer frame region may not be a rectangular shape.

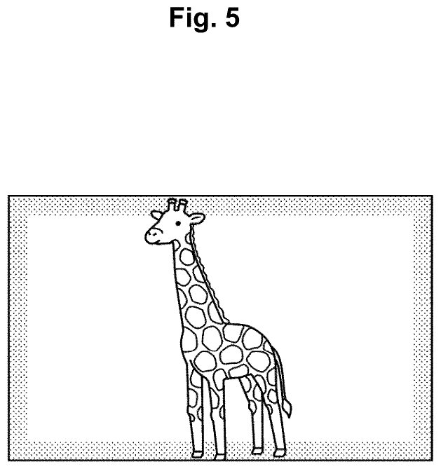

FIG. 5 is a diagram illustrating a state in which an object labeled in the region of interest protrudes into the outer frame region. As illustrated in FIG. 5, in a case where an object, such as a person, a car, or an animal, to which a label corresponding to a region of interest is given protrudes into the outer frame region, the region setting unit 11 also sets a portion where the object protrudes into the outer frame region as the center region.

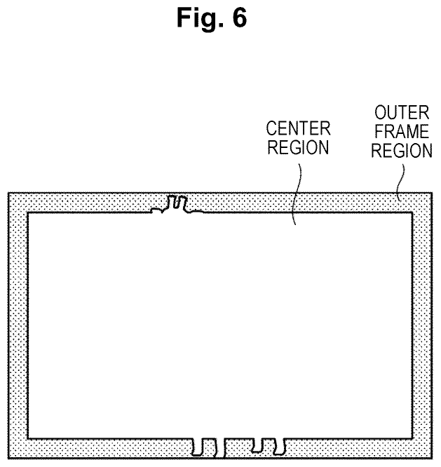

As illustrated in FIG. 6, the center region is enlarged by the contour of the protruding object. The data processing device 1 performs generation of a histogram (step S2 in FIG. 4), clustering of the histogram and generation of a mapping function (step S3), and correction of a depth value using the mapping function (step S4) for this region.

On the other hand, a process is performed in which the outer frame region is reduced only by the contour portion of the object and a depth value of the region is continuously connected to the corrected depth value of the center region (step S5).

That is, for example, in a case where there is segmentation information input from an external processing block and there is an object to which a label corresponding to a region of interest such as a person or a car is given in the outer frame region, the depth value is not corrected in the region. This is to avoid that a feeling of wrongness with 3D rather becomes conspicuous by correcting the depth of the object of interest.

The data processing device 1 may perform a depth value correction process only in a case where an original image of a target portion is flat. That is, the region setting unit 11 sets the outer frame region in a region where a variance value of pixel values is smaller than a predetermined threshold value. That is, in a case where an original image is excessively fine, the process may not be performed. The definition of the image can be determined by, for example, a maximum value/a minimum value or a variance value of pixel values.

That is, in a case where a value such as a variance value of the luminance of the original image in the outer frame region (for example, ten pixels from the 0-th column to the ninth column in FIG. 3) is equal to or greater than a threshold value freely set in advance, a depth value is not corrected. This is because a region having fine high-frequency components in the original image is likely to be a region of interest, and a feeling of wrongness with 3D may rather be conspicuous by correcting the depth.

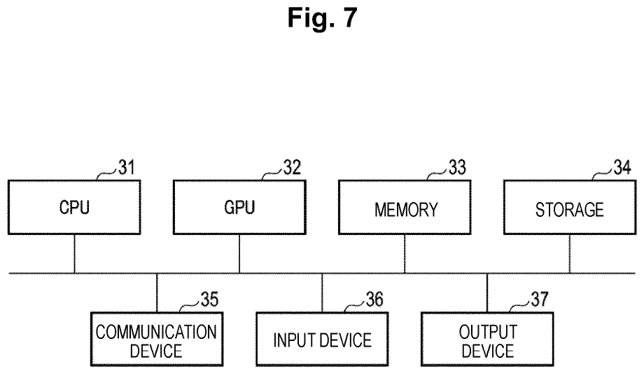

As the region setting unit 11, the histogram generation unit 12, the mapping function generation unit 13, the correction processing unit 14, and the optimization processing unit 15 described above, for example, a computer including a central processing unit (CPU) 31, a graphic processing unit (GPU) 32, a memory 33, a storage 34, a communication device 35, an input device 36, and an output device 37 as illustrated in FIG. 7 may be used. In this computer, the CPU 31 and the GPU 32 execute a program loaded in the memory 33 to realize the region setting unit 11, the histogram generation unit 12, the mapping function generation unit 13, the correction processing unit 14, and the optimization processing unit 15. The program may be recorded on a computer-readable recording medium such as an optical disk or a semiconductor memory, or may be distributed via a network.

The present invention is not limited to the above embodiment. For example, depth values have been described as 8-bit 256 grayscales, but are not limited to thereto. The flow of each process described above is not limited to the described procedure, and the order of some steps may be changed, or some steps may be performed simultaneously in parallel. Also, the series of processes described above does not need to be executed continuously in terms of time, and each step may be executed at any timing.

The program for performing the above processes may be stored in a computer-readable recording medium (or a storage medium) to be provided. The program is stored in a recording medium as a file in an installable format or a file in an executable format. Examples of the recording medium include a magnetic disk, an optical disk (such as a CD-ROM, a CD-R, a DVD-ROM, or a DVD-R), a magneto-optical disk (such as an MO), and a semiconductor memory. The program for performing the above processes may be stored in a computer (a server) connected to a network such as the Internet, and be downloaded into the computer (a client) via the network.

A histogram clustering method, a depth layer setting method, a mapping function generation method, and the like can be variously modified without departing from the concept of the present invention.

The data processing device according to the embodiment can construct the operation of each component as a program, install the program in a computer used as the data processing device, and cause the program to be executed, or distribute the program via a network. The present invention is not limited to the above embodiment, and various modifications and applications are possible.

In short, this invention is not limited to the above embodiment, and various modifications can be made in the implementation stage without departing from the scope thereof. Also, embodiments may be implemented in an appropriate combination, and, in that case, effects as a result of the combination can be achieved. The above embodiments include various types of inventions, and various types of inventions can be extracted by a combination selected from a plurality of disclosed constituents. For example, even if some constituents are eliminated from all the constituents described in the embodiment, a configuration from which the constituents are eliminated can be extracted as an invention in a case where the problem can be solved and the advantageous effects can be achieved.

### REFERENCE SIGNS LIST

1 Data processing device
2 Display surface
11 Region setting unit
12 Histogram generation unit
13 Mapping function generation unit
14 Correction processing unit
15 Optimization processing unit
31 CPU
33 Memory
34 Storage
35 Communication device
36 Input device
37 Output device

1. A data processing device that processes a depth map in which a depth value is mapped to each pixel of an image displayed on a display, the data processing device comprising:
region setting circuitry that sets a contact region in contact with a display surface in the depth map that is a processing target:
histogram generation circuitry that generates a histogram in which the number of pixels belonging to each bin is associated with one of a plurality of bins dividing a range of depth values for a non-contact region that is a region other than the contact region of the depth map:
mapping function generation circuitry that performs clustering of the histogram into a plurality of depth layers and generates a mapping function for converting a depth value of the non-contact region into a value based on the clustering:
first correction processing circuitry that corrects the depth value of the non-contact region by using the mapping function: and
second correction processing circuitry that corrects the depth value of the contact region and continuously connects the depth value of the contact region to the corrected depth value of the non-contact region.

2. The data processing device according to claim 1, wherein:
the region setting circuitry sets a frame-shaped region having a width corresponding to a size of the image as the contact region.

3. The data processing device according to claim 1, wherein:
the region setting circuitry sets the contact region in a region where a variance value of pixel values is smaller than a predetermined threshold value.

4. The data processing device according to claim 1, wherein:
in a case where an object to which a label corresponding to a region of interest is given protrudes from the non-contact region into the contact region, the region setting circuitry also sets a portion where the object protrudes into the contact region as the non-contact region.

5. A data processing method to process a depth map in which a depth value is mapped for each pixel of an image displayed on a display, the data processing method comprising:
setting a contact region in contact with a display surface in the depth map that is a processing target;
generating a histogram in which the number of pixels belonging to each bin is associated with one of a plurality of bins dividing a range of depth values for a non-contact region that is a region other than the contact region of the depth map;
performing clustering of the histogram into a plurality of depth layers and generating a mapping function for converting a depth value of the non-contact region into a value based on the clustering;
correcting the depth value of the non-contact region by using the mapping function; and
correcting the depth value of the contact region and continuously connecting the depth value of the contact region to the corrected depth value of the non-contact region.

6. A non-transitory computer readable medium storing a program for causing a computer to perform the data processing method of claim 5.
